(19) United States
(12) Patent Application Publication
(10) Pub. No.: US 2014/0123506 A1
(43) Pub. Date: May 8, 2014

(54) Razor with Safety Features for Use in a Correctional Facility

(71) Applicant: Mark Gaines, Willow Spring, NC (US)

(72) Inventor: Mark Gaines, Willow Spring, NC (US)

(21) Appl. No.: 13/671,310

(22) Filed: Nov. 7, 2012

(51) Int. Cl. B26B 21/06

(52) U.S. Cl. CPC B26B 21/06
USPC 30/526

(57) ABSTRACT

A razor generally having a blade, a housing, and a handle. The razor is particularly effective for use in a correctional institution because it is designed to prevent and/or eliminate its use as a whole or in part as a weapon. The handle may be flexible to prevent its use as a stabbing weapon. The handle may also include a fire retardant material to prevent it from being used in a fire. The housing extends around the blade and may be constructed from multiple sections. The sections may be securely joined together to prevent disassembly to access the blade.

### BACKGROUND

The present application is directed to razors and, more particularly, to razors designed for persons housed in a correctional institution to prevent their use as a weapon.

Razors are used in everyday life for shaving various body parts, such as the face and neck. The razors generally include a blade, a housing that holds the blade, and a handle that connects to and extends outward from the housing. Razors used in correctional institutions, such as prisons and detention facilities, require additional safeguards. These safeguards include a construction that prevents taking the razor apart such that the razor as a whole, or any one or more parts of the razor, cannot be used as a weapon. The safeguards may also include preventing one or more portions of the razor from being used to start a fire.

One potential issue with conventional razors is the ability of a user to craft the handle into a weapon. A user may sharpen the end of the handle opposite from the blade into a point. The user is then able to grasp the housing in their hand with the sharpened handle extending outward to use the razor as a weapon and potentially hurt others.

Another manner of crafting a weapon is to remove the blade from the housing. The blade can either be attached to another object or held directly by the user. The one or more sharpened edges of the blade are exposed and can again be used as a weapon.

Therefore, razors for institutional use should be constructed in a manner that prevents their use as a weapon. The razors may also be constructed to reduce or eliminate alterations. Further, the construction may provide for alterations to be visible to a person monitoring the user.

### SUMMARY

The present application is directed to a razor that is particularly applicable to use in a correctional institution. In one embodiment, the razor includes a blade with a sharpened edge. The razor also includes a housing that extends around the blade and includes a slot aligned with the sharpened edge such that the sharpened edge is exposed to shave the user and a remainder of the blade is enclosed within the housing to prevent contact with the user. A flexible handle extends outward from the housing and has an elongated shape with a first end at the housing and an opposing second end. The handle is constructed from a thermoplastic rubber, and also from a flame retardant material to prevent the handle from being ignited by the user.

The housing may be constructed from different materials than the handle and may include a sleeve that extends over the first end of the handle and over a longitudinal section of the handle. The housing may be translucent and the handle may be opaque with the first end and the longitudinal section of the handle being visible through the sleeve. The blade may include a flattened shape with opposing first and second faces and the sharpened edge extending between the faces. The housing may be constructed from a first section that extends over the first face of the blade and a second section that extends over the opposing second face of the blade. The first and second sections may be connected together by one or more ultrasonic welds. Holes may extend through the blade and posts may extend through the holes and connect to the first and second sections. The housing may be translucent with the blade being visible within an interior of the housing. The handle and the first section of the housing may include a unitary, one-piece construction. The fire retardant material may be coated on an exterior of the thermoplastic rubber. The housing may be constructed of a polycarbonate that is less flexible than the thermoplastic rubber of the handle.

Another embodiment of the razor includes a blade having a sharpened edge and openings that extend between opposing first and second faces. A housing includes a first section positioned over the first face of the blade and a second section positioned over the second face of the blade. The first and second sections are connected together by seams that prevent the sections from being separated. The housing further includes posts that extend between the first and second sections and through the openings in the blade to further connect the sections together. The housing includes a slot aligned with the sharpened edge such that the sharpened edge is exposed to shave the user with a remainder of the blade being enclosed within the housing to prevent contact with the user. The razor also includes a flexible handle that extends outward from the first section of the housing and has an elongated shape that extends away from the second section of the housing.

Another embodiment of the razor includes a blade having a sharpened edge and openings that extend through the blade between opposing first and second faces. The razor also includes: a housing with a first section positioned over the first face of the blade and a second section positioned over the second face of the blade, the first and second sections being connected and forming an interior space that houses the blade; seams that extend along joints formed between the sections to prevent the sections from being separated; posts that extend outward from the first and second sections and across the interior space and through the openings in the blade to further connect the sections; a slot formed by the first and second sections that is aligned with the sharpened edge such that the sharpened edge is exposed from the housing; and a sleeve that extends outward from the first section and includes a cavity. The razor also includes a flexible handle having an elongated shape with a first end positioned within the cavity formed in the sleeve and an opposing second end. The handle is constructed from a thermoplastic rubber, and a flame retardant material to prevent the handle from being ignited by the user.

The various aspects of the various embodiments may be used alone or in any combination, as is desired.

### BRIEF DESCRIPTION OF THE DRAWINGS

FIG. 1 is a top view of a razor that includes a handle, housing, and a blade.

FIG. 2 is a side view of a razor.

FIG. 3 is side view of a razor handle in a first orientation illustrated in solid lines and bent orientations illustrated in dashed lines.

FIG. 4 is a top view of a razor handle in a first orientation illustrated in solid lines and bent orientations illustrated in dashed lines.

FIG. 5 is a partial perspective view of a neck at a first end of a handle.

FIG. 6 is a sectional view cut along line VI-VI of FIG. 1 of a handle.

FIG. 7 is a perspective view of a blade.

FIG. 8 is a top perspective view of a razor and a protective cover.

FIG. 9 is an exploded perspective view of a razor.

### DETAILED DESCRIPTION

The present application is directed to a razor, particularly effective for use in a correctional institution. The razor is designed to prevent and/or eliminate its use in whole or in part as a weapon. The razor may include a flexible handle to prevent its use as a stabbing weapon. The handle may also include a fire retardant material to prevent it from being used to start a fire. The razor may also include a housing that extends around a blade. The housing is constructed from multiple sections that are securely joined together to prevent a user from disassembling the housing to access the blade.

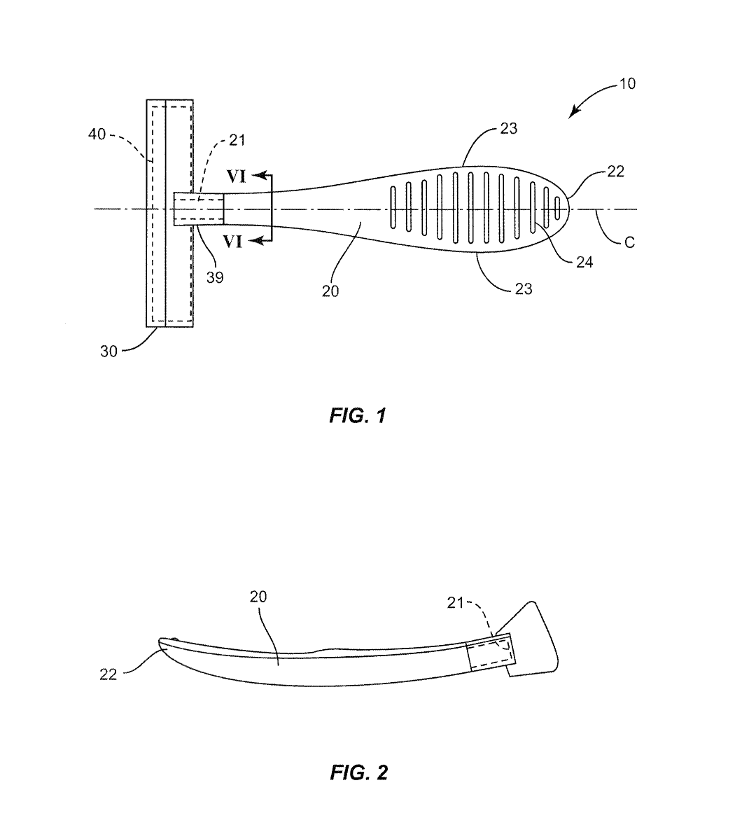

FIG. 1 illustrates the razor 10 that includes a handle 20, a housing 30 attached to an end of the handle 20, and a blade 40 positioned within the housing 30. The design includes one or more features that prevent and/or eliminate the ability of the user to craft the razor 10 a weapon. Further, the razor 10 may be configured such that alterations, such as those that may occur when a user is attempting to make a weapon, are readily apparent to a viewer.

The handle 20 includes an elongated shape with a first end 21 and an opposing second end 22. The handle 20 further includes lateral edges 23 that extend between the first and second ends 21, 22. As illustrated in FIG. 1, the lateral edges 23 bow outward in proximity to the second end 22 forming wider gripping sections 24 on opposing first and second sides. Gripping features, such as ribs or knurled surfaces, may extend over a portion or entirety of the gripping sections 24 to facilitate gripping by the user.

When viewed from a top view as illustrated in FIG. 1, a longitudinal centerline C extends along the handle 20 and through each of the first and second ends 21, 22. As illustrated from the side in FIG. 2, the handle 20 may include a slight bow along the length of the centerline C. The bow may facilitate grasping and manipulation by the user during shaving.

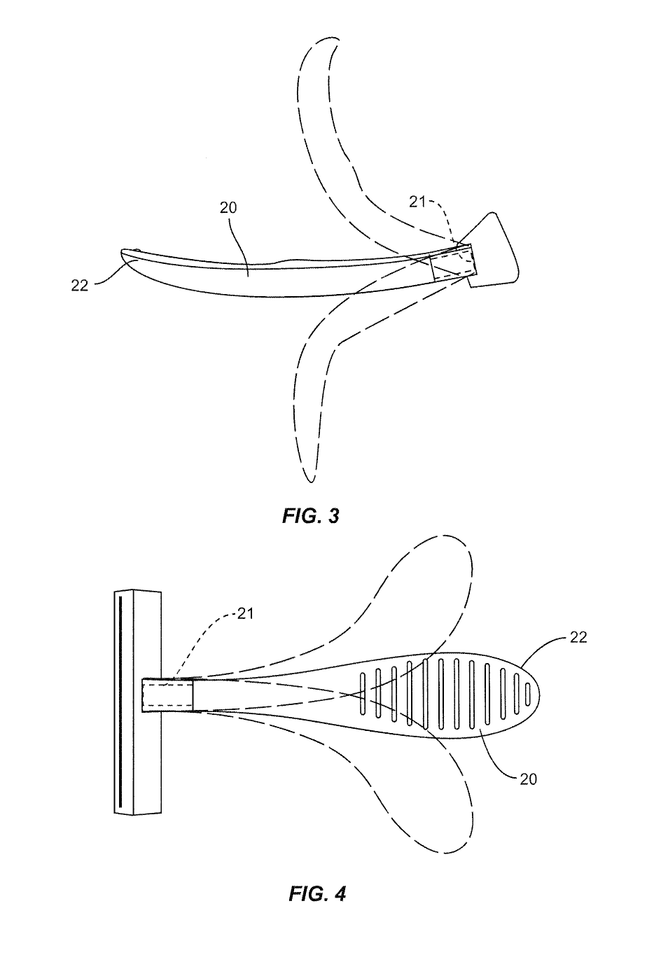

The handle 20 is flexible and able to be bent along and across the centerline C. FIG. 3 illustrates a side view of the handle 20 that is flexible in opposing vertical directions as indicated by the orientations of the dashed lines. This includes an “upward” direction and an opposing “downward” direction. The handle is also flexible in lateral directions as illustrated in FIG. 4 and may be flexed in either lateral direction as indicated. The handle 20 is further simultaneously flexible in both vertical and lateral directions.

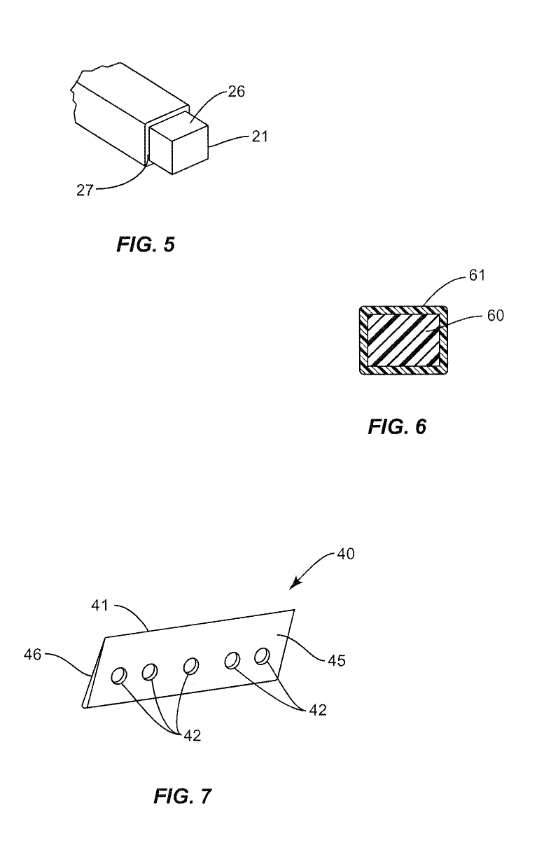

The first end 21 of the handle 20 may further include a neck 26 as illustrated in FIG. 5. The neck 26 provides for connecting with the housing 30 as will be explained in more detail below. The neck 26 extends inward from the first end 21 and terminates at a back wall 27. The neck 26 has a smaller cross-sectional area than an adjacent section of the handle 20 beyond the back wall 27.

The handle 20 may be constructed from a variety of different materials 60, including but not limited to thermoplastic rubber and plastic. The handle 20 may further be treated with a fire retardant material 61 to prevent burning of the handle 20 by a user. A variety of different fire retardant materials 61 may be used, including but not limited to decabromobibenzyl, diantimonytrioxide, and combinations thereof.

In one embodiment, the fire retardant 61 is incorporated into the handle material 60 when both are in a viscous state. The combined material 60 and fire retardant 61 are then injected into a mold to form the handle 20 during the molding process. In another embodiment, the fire retardant material 61 is coated to the exterior of the handle 20. FIG. 6 illustrates one example with the fire retardant 61 extending along the exterior surface of the handle material 60. The thickness of the coating may vary depending upon the type of fire retardant 61 and the handle material 60. In the various embodiments, the fire retardant does not prevent the handle 20 from being flexible.

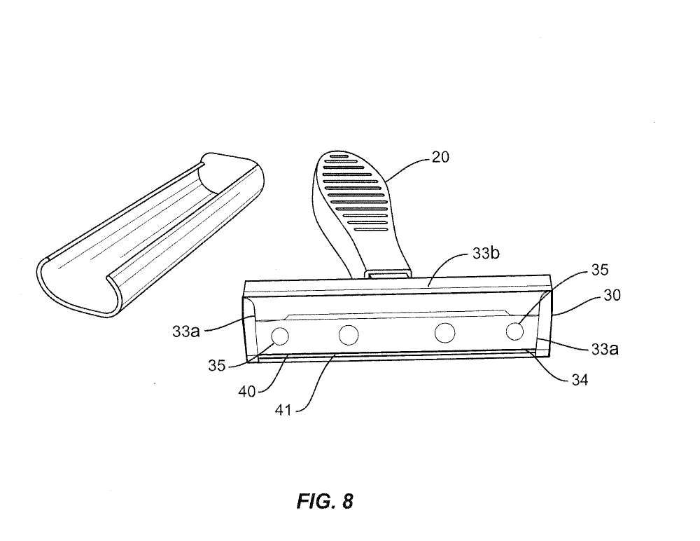

The blade 40 is positioned in and protected by the housing 30. FIG. 7 illustrates a blade 40 removed from the housing 30 and including a flattened shape with opposing first and second faces 45, 46. A sharpened edge 41 extends along one side at the intersection of the faces 45, 46. The blade 40 further includes one or more holes 42. The holes 42 may be aligned in a straight line to weaken the blade 40 and causing it to break if a user were to attempt to remove it from the housing 30. Further, the blade 40 would break if it was removed intact from the housing 30 and attempted to be used as a weapon. The holes 42 may include the same size and shape, or may include multiple sizes and/or shapes.

FIG. 8 illustrates the blade 40 positioned and supported within the housing 30. The housing 30 extends around and prevents removal of the blade 40. The housing 30 includes a slot 34 that extends along the length through which the sharpened edge 41 of the blade 40 extends for shaving the user. The housing 30 may extend around the remainder of the blade 40.

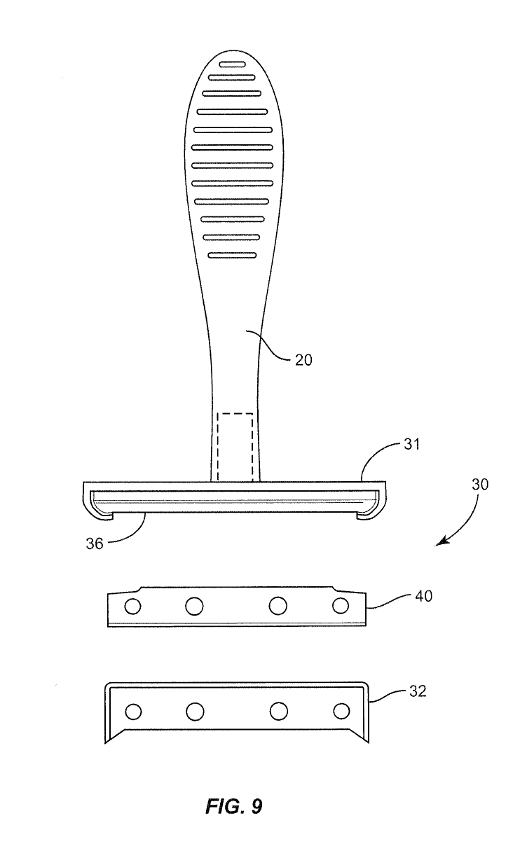

FIG. 9 illustrates an exploded view of the housing 30 and the blade 40. The housing 30 includes a first section 31 and a second section 32 that attach together to extend around and enclose the blade 40. The second section 32 is sized to fit over the blade 40 and engage with the first section 31. The first and second sections 31, 32 are shaped and sized to form the housing that extends around the blade 40.

The first and second sections 31, 32 are connected together in a non-removable manner as illustrated in FIG. 8. The connection may include one or more seams 33 and/or posts 35 made by ultrasonic welding. The seams 33 connect together the first and second sections 31, 32 and extend around an entirety or portion of the blade 40. In one embodiment, three seams 33 extend along the surfaces of the second section 32 that contact with the first section 31. As illustrated in FIG. 8, a pair of seams 33a extends along the relatively short sides of the blade 40, and a longer seam 33b extends along the elongated side of the blade 40. Further, one or more posts 35 extend through holes 42 in the blade 40 and connect the two sections 31, 32. The posts 35 may also be formed by ultrasonic welding.

These ultrasonic connections mesh together the first and second sections 31, 32. The connections may remove any junctions between the sections 31, 32 that include edges or dips that could be picked apart by the user or compromised with a tool by the user.

In another embodiment, the sections 31, 32 are connected together by an adhesive. This may be in combination with the seams 33, or in place of the seams 33.

One or both of the sections 31, 32 of the housing 30 may be constructed from a variety of materials, including but not limited to polycarbonate. The material may also be translucent to facilitate inspection of the housing 30 and blade 40. The first and second sections 31, 32 may each be constructed from the same or different materials.

The housing 30 may be a separate component from the handle 30 and attached during the manufacturing process. A sleeve 39 (FIG. 1) may extend outward from a back side of the first section 31. The sleeve 39 includes a cavity that is sized to extend over the first end 21 of the handle 20. In one embodiment, the handle 20 includes a neck 26 at the first end 21 as illustrated in FIG. 5. The sleeve 39 is sized to extend over the neck 26 and abut against the back wall 27. The housing 30 may be attached to the handle 20 through one or more of adhesives, mechanical fasteners, and ultrasonic welding.

In another embodiment, the first section 31 and the handle 20 are constructed as a single piece. In one specific embodiment, the handle and first section 31 are formed together in a molding process. The handle 20 and first section 31 may each be constructed from a thermoplastic rubber.

The housing 30 may be transparent such that the blade 40 is visible. Further, the section of the handle 20 within the sleeve 39 may also be visible. This facilitates monitoring of the razor 10 by supervisory personal to make certain the razor 10 has not been damaged or made into a weapon. Further, the handle 20 may be brightly colored to again facilitate viewing by a supervisor. The bright color may also make it difficult for a user to hide the razor 10.

In the embodiment described above, the blade 40 includes a single sharpened edge 41. Other embodiments may include the blade 40 having two sharpened edges that extend along opposing sides. Further, the housing 30 is configured to have a pair of openings such that both edges are exposed and may be used to shave the user.

Spatially relative terms such as “under”, “below”, “lower”, “over”, “upper”, and the like, are used for ease of description to explain the positioning of one element relative to a second element. These terms are intended to encompass different orientations of the device in addition to different orientations than those depicted in the figures. Further, terms such as “first”, “second”, and the like, are also used to describe various elements, regions, sections, etc. and are also not intended to be limiting. Like terms refer to like elements throughout the description.

As used herein, the terms “having”, “containing”, “including”, “comprising” and the like are open ended terms that indicate the presence of stated elements or features, but do not preclude additional elements or features. The articles “a”, “an” and “the” are intended to include the plural as well as the singular, unless the context clearly indicates otherwise.

The present invention may be carried out in other specific ways than those herein set forth without departing from the scope and essential characteristics of the invention. The present embodiments are, therefore, to be considered in all respects as illustrative and not restrictive, and all changes coming within the meaning and equivalency range of the appended claims are intended to be embraced therein.

What is claimed is:

1. A razor for shaving a user housed in a correctional facility, the razor comprising:
a blade having a sharpened edge;
a housing that extends around the blade and includes a slot aligned with the sharpened edge such that the sharpened edge is exposed to shave the user, the housing extending around a remainder of the blade; and
a flexible handle extending outward from the housing and comprising an elongated shape with a first end at the housing and an opposing second end, the handle constructed from a thermoplastic rubber, the handle also constructed from a flame retardant material to prevent the handle from being ignited by the user.

2. The razor of claim 1, wherein the housing is constructed from different materials than the handle and includes a sleeve that extends over the first end of the handle and over a longitudinal section of the handle.

3. The razor of claim 2, wherein the housing is translucent and the handle is opaque with the first end and the longitudinal section of the handle being visible through the sleeve.

4. The razor of claim 1, wherein the blade includes a flattened shape with opposing first and second faces and the sharpened edge extends between the faces, the housing being constructed from a first section that extends over the first face of the blade and a second section that extends over the opposing second face of the blade, the first and second sections being connected together by one or more ultrasonic welds.

5. The razor of claim 4, further comprising holes that extend through the blade and posts that extend through the holes and connect to the first and second sections.

6. The razor of claim 5, wherein the housing is translucent with the blade being visible within an interior of the housing.

7. The razor of claim 4, wherein the handle and the first section of the housing include a unitary, one-piece construction.

8. The razor of claim 1, wherein the fire retardant material is coated on an exterior of the thermoplastic rubber.

9. The razor of claim 1, wherein the housing is constructed of a polycarbonate that is less flexible than the thermoplastic rubber of the handle.

10. A razor for shaving a user housed in a correctional facility, the razor comprising:
a blade having a sharpened edge and holes that extend between opposing first and second faces;
a housing including a first section positioned over the first face of the blade and a second section positioned over the second face of the blade, the first and second sections being connected together by welds that prevent the sections from being separated, the housing further including posts that extend between the first and second sections and through the holes in the blade to further connect the sections together, the housing including a slot aligned with the sharpened edge such that the sharpened edge is exposed to shave the user with a remainder of the blade being enclosed within the housing; and
a flexible handle extending outward from the first section of the housing and comprising an elongated shape.

11. The razor of claim 10, wherein the housing is translucent with the blade being visible within an interior of the housing that is formed between the first and second sections.

12. The razor of claim 11, wherein the housing is constructed from a polycarbonate such that the housing is less flexible than the handle.

13. The razor of claim 10, wherein the openings are each positioned a common distance away from the sharpened edge and are aligned across the blade in a straight line.

14. The razor of claim 10, wherein the first section of the housing is less flexible than the handle and includes a sleeve that extends outward and over the first end and a first section of the handle, the handle being attached within the sleeve and being flexible in multiple different directions.

15. A razor for shaving a user housed in a correctional facility, the razor comprising:
a blade having a sharpened edge and openings that extend through the blade between opposing first and second faces;
a housing including:
a first section positioned over the first face of the blade and a second section positioned over the second face of the blade, the first and second sections being connected and forming an interior space that houses the blade;
seams that extend along joints formed between the sections to prevent the sections from being separated,
posts that extend outward from the first and second sections and across the interior space and through the openings in the blade to further connect the sections,
a slot formed by the first and second sections and being aligned with the sharpened edge such that the sharpened edge is exposed from the housing;
a sleeve that extends outward from the first section and includes a cavity; and
a flexible handle having an elongated shape with a first end positioned within the cavity formed in the sleeve and an opposing second end, the handle constructed from a thermoplastic rubber, the handle also constructed from a flame retardant material to prevent the handle from being ignited by the user.

16. The razor of claim 15, wherein the housing extends over a remainder of the blade other than the sharpened edge to enclose the blade and prevent contact with the user.

17. The razor of claim 15, wherein the first section of the housing is constructed from a polycarbonate and is less flexible than the handle.

18. The razor of claim 15, wherein the housing is translucent and the handle is opaque with the first end of the handle being visible through the sleeve.

19. The razor of claim 15, wherein the fire retardant material is a coating positioned on an exterior of the thermoplastic rubber.
